(19) United States
(12) Patent Application Publication
(10) Pub. No.: US 2015/0110283 A1
(43) Pub. Date: Apr. 23, 2015

(54) SYSTEM FOR CONTROLLING FAN NOISE

(71) Applicants: Inventec (Pudong) Technology Corporation, Shanghai (CN); INVENTEC CORPORATION, TAIPEI CITY (TW)

(72) Inventors: Yi-Lun CHENG, TAIPEI CITY (TW); Kuo-Chi TING, TAIPEI CITY (TW)

(73) Assignees: INVENTEC CORPORATION, TAIPEI CITY (TW); Inventec (Pudong) Technology Corporation, Shanghai (CN)

(21) Appl. No.: 14/230,011

(22) Filed: Mar. 31, 2014

(30) Foreign Application Priority Data
Oct. 22, 2013 (CN) 201310499365.9

(51) Int. Cl. H04R 3/00; G06F 1/20

(52) U.S. Cl. CPC H04R 3/002; G06F 1/20
USPC 381/71.1

(57) ABSTRACT

A system for controlling fan noise includes a fan, a sensor, a signal processing unit, a net structure, and a piezoelectric element. The fan has an airflow inlet and an airflow outlet. The sensor is disposed near the airflow outlet and is used for receiving a sound signal made by the fan. After the signal processing unit receives the sound signal sent by the sensor, the signal processing unit provides an inversed phase signal by analysis and computation. The net structure is disposed at the airflow inlet. The piezoelectric element is disposed on the net structure. When the piezoelectric element receives the inversed phase signal provided by the signal processing unit, the piezoelectric element vibrates the net structure, so that the net structure generates an inversed phase sound to offset a noise made by the fan.

### RELATED APPLICATIONS

This application claims priority to Chinese Application Serial Number 201310499365.9, filed Oct. 22 2013, which are herein incorporated by reference.

### BACKGROUND

With the development of technologies, the efficiencies of electronics become better and better. However, in the meantime, the heat the electronics generate increases as well. In order to avoid overheating to damage electronics, fans used for helping dissipate heat is an important part of the electronics.

Fan noises may make people feel different levels of anxiety. If disturbed by fan noises for a long time, people may feel tired and the work performance may become lower. Even worse, fan noises may cause psychological and physical harm.

General fan noise control methods lower the noises mainly by specific structure design. The methods include specific structure design of shell shape, fan shape, vanes or ribs and soundproofing devices. However, the above methods have no significant effect on low-frequency noises. How to effectively eliminate low-frequency noises made by the fans is an important issue in the associated industries.

### SUMMARY

This disclosure provides a system for controlling fan noise system for controlling fan noise.

In one embodiment, a system for controlling fan noise is provided. The system includes a fan, a sensor, a signal processing unit, a net structure, and a piezoelectric element. The fan has an airflow inlet and an airflow outlet. The sensor is receives a sound signal made by the fan. The signal processing unit receives the sound signal sent by the sensor and analyzes the sound signal to compute an inversed phase signal. The net structure is disposed at the airflow inlet. The piezoelectric element receives the inversed phase signal provided by the signal processing unit and vibrates according to the inversed phase signal so as to drive the net structure to vibrate and generate an inversed phase sound to offset a noise made by the fan.

In another embodiments, a system for controlling fan noise is provided. The system includes a fin set, a fan, a sensor, a signal processing unit, a net structure, and a piezoelectric element. The fin set has a front side and a rear side opposite to the front side. The fan is disposed adjacent to the front side and has an airflow inlet and an airflow outlet, and the airflow outlet faces the front side. The sensor is disposed near the rear side and is used for receiving a sound signal made by the fan. The signal processing unit receives the sound signal sent by the sensor and analyzes the sound signal to compute an inversed phase signal. The net structure is disposed at the airflow inlet. The piezoelectric element is disposed on the net structure. The piezoelectric element receives the inversed phase signal provided by the signal processing unit and vibrates according to the inversed phase signal so as to drive the net structure to vibrate and generate an inversed phase sound to offset a noise made by the fan.

In one or more embodiments, the sound signal is a mixed signal of a sound made by the net structure and a sound made by the fan.

In one or more embodiments, the fan and the sensor are separated to assure that the mixed signal is thoroughly mixed by the sound made by the fan and the sound made by the net structure.

In one or more embodiments, the fan has four corners, the net structure has four fixing members, and the net structure is fixed to the corners via the fixing members.

In one or more embodiments, the piezoelectric element is disposed at the center of the net structure.

In one or more embodiments, the fan has a rotation speed detection module for providing the signal processing unit a fan rotation speed signal as a reference signal for analyzing and computing the inverted phase signal.

In one or more embodiments, the fin set is columnar and has a long edge, and the front side and the rear side are respectively disposed at both ends of the long edge.

In one or more embodiments, the system further includes a motherboard. The motherboard has a central processing unit, and the fin set is disposed on the central processing unit.

By vibrating the net structure, which is disposed at the airflow inlet and prevents dust or dirt from entering the fan, the inversed phase sound is generated according to the active noise cancellation, so as to effectively eliminate the noise made by the fan.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows.

FIG. 1 is a schematic perspective view of the system for controlling fan noise according to one embodiment of this invention;

FIG. 2A is block diagram of the system according to one embodiment of this invention;

FIG. 2B is a block diagram of the system according to another embodiment of this invention; and

FIG. 3 is a perspective view of the system installed in a personal computer according to one embodiment of this invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically depicted in order to simplify the drawings.

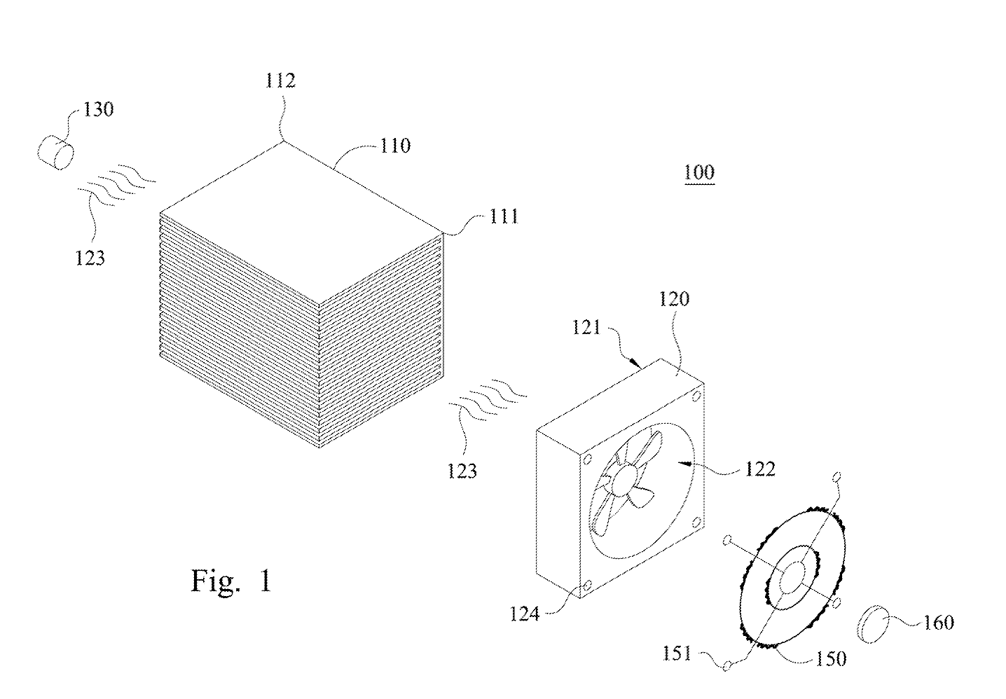

FIG. 1 is a schematic perspective view of the system for controlling fan noise according to one embodiment of this invention. A system 100 for controlling fan noise is provided. The system 100 is a fan module. The fan module can be installed in the personal computer or the server host and can be used for dissipating heat generated by a central processing unit.

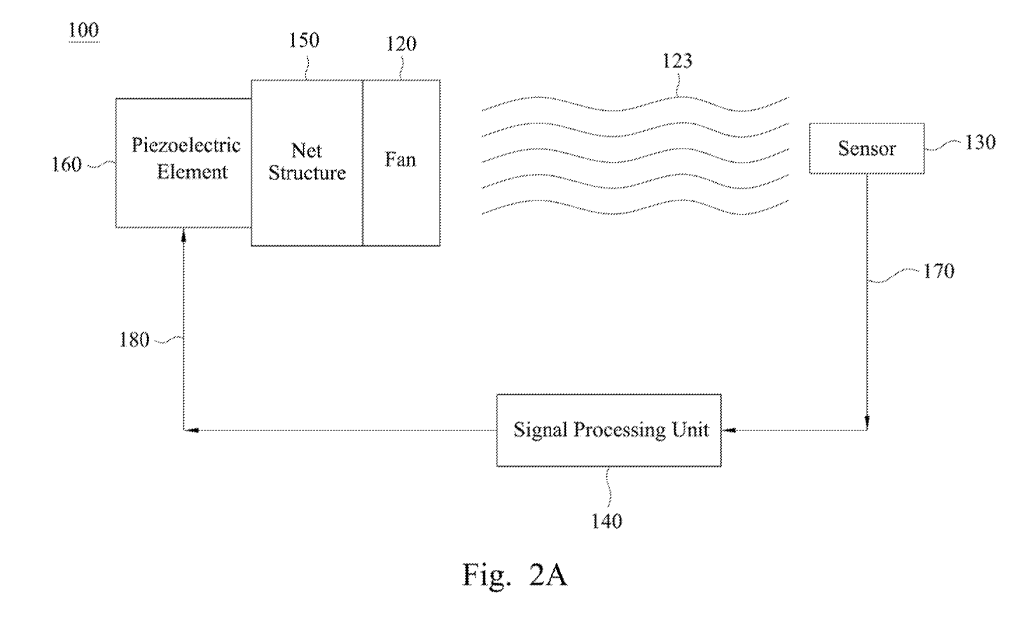

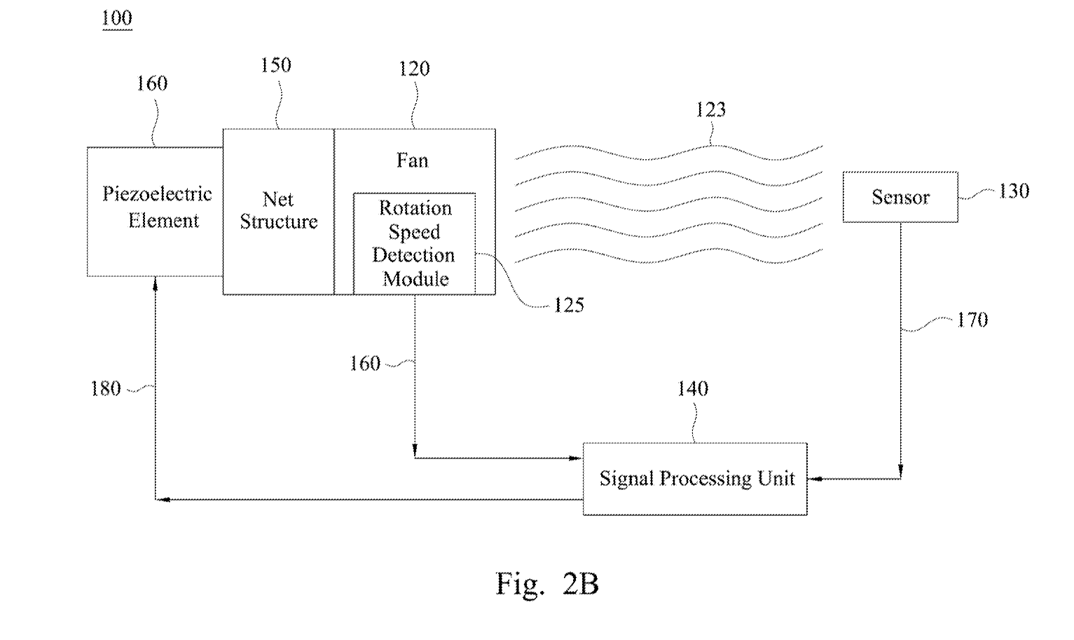

FIG. 2A is a block diagram of the system according to one embodiment of this invention. As shown in FIG. 1 and FIG. 2A, the system 100 includes a fan 120, a sensor 130, a signal processing unit 140, a net structure 150, and a piezoelectric element 160. The fan 120 has an airflow outlet 121 and an airflow inlet 122. The sensor 130 is disposed near the airflow outlet 121 and receives a sound signal 170 made by the fan 120. The signal processing unit 140 receives the sound signal 170 sent by the sensor 130 and analyzes the sound signal 170 to compute an inversed phase signal 180. The net structure 150 is disposed at the airflow inlet 122. The piezoelectric element 160 receives the inversed phase signal 180 provided by the signal processing unit 140 and vibrates according to the inversed phase signal 180 so as to drive the net structure 150 to vibrate and generate an inversed phase sound to offset a noise made by the fan 120.

The system 100 is mainly used for eliminating low-frequency noise. When blades of the fan 120 are rotating and generating airflow 123, the airflow 123 may become inhomogeneous in time series due to the rotation of the blades, and the inhomogeneous airflow 123 forms a low and single frequency noise, or so called blade passing tone. The system 100 adopts active noise cancellation to eliminate fan noise. In other words, the method eliminates noises by emitting another sound to cancel out the noises.

The system 100 uses a secondary sound source to generate an offsetting sound to offset the noise made by the fan 120 and to achieve noise control. The net structure 150 is the secondary sound source, which is suitable for vibrating and generating a low-frequency sound to cancel out the low-frequency noise. Specifically, as show in FIG. 2A, after the sensor 130 receives the sound signal 170 made by the fan 120, the sensor 130 sends the sound signal 170 to the signal processing unit 140. After the sound signal 170 is received by the signal processing unit 140, the signal processing unit 140 performs analysis and computation to obtain an inversed phase signal 180 with a same magnitude but opposite phase of the sound signal 170, and the signal processing unit 140 sends the inversed phase signal 180 to the piezoelectric element 160. The piezoelectric element 160 vibrates according to the inversed phase signal 180 sent by the signal processing unit 140 to drive the net structure 150 to vibrate and to generate the inversed phase sound as the offsetting sound. The inversed phase sound may cancel out the fan noise, so as to achieve noise control.

The fan 120 and the sensor 130 are separated to assure that the sound signal 170 is thoroughly mixed by a sound made by the fan 120 and a sound made by the net structure 150. Specifically, after the fan 120 starts operate, the net structure 150 does no make any sound, so the sound signal 170 received by the sensor 130 is the noise made by the fan 120. Then, the net structure 150 vibrates and generates the offsetting sound to offset the noise made by the fan 120. However, after the offsetting sound generated by the net structure 150 interferes with the noise made by the fan 120, the noise may not be cancelled out due to a calculation error or other error factors. At this time, the sensor 130 can receive the sound signal 170 again, and the sound signal 170 now is a mixed signal of the sound made by the fan 120 and the sound made by the net structure 150. After the signal processing unit 140 receives the sound signal 170 mixed by the sound made by the fan 120 and the sound made by the net structure 150, the signal processing unit 140 obtains a compensation signal with an opposite phase of the sound signal 170 by analysis and computation, and then the signal processing unit 140 obtains the new inversed phase signal 180 by adding the compensation signal and the previous inversed phase signal 180 together. Then the signal processing unit 140 commands the piezoelectric element 160 to vibrate according to the new inversed phase signal 180 to drive the net structure 150 to vibrate, so as to offset the noise made by the fan 120. The above procedure can be repeated several times to achieve the best result. The time interval between every calculation of the inversed phase signal 180 can be shorter than one second, so the correction procedure can be completed quickly and the noise can be eliminated in a short time. Moreover, when characteristics of the fan noise changes due to a change of an external situation, for example, a rotation speed of the fan 120 changes due to a change of a temperature of a motherboard, the above operation procedure can make correction in accordance with external situations timely.

The sensor 130 can be a microphone or other devices which are able to detect sound. People having ordinary skill in the art can make proper modification to the sensor 130 according to their actual needs.

The signal processing unit 140 can be a processor. People having ordinary skill in the art can make proper modification to the signal processing unit 140 according to their actual needs.

The material of the net structure 150 can be a metal such as copper or iron. People having ordinary skill in the art can make proper modification to the material of the net structure 150 according to their actual needs.

FIG. 26 is a block diagram of the system according to another embodiment of this invention. As shown in FIG. 26, the fan 120 can have a rotation speed detection module 125 for providing the signal processing unit 140 a fan rotation speed signal 126 as a reference signal for analyzing and computing the inversed phase signal 180. The rotation speed detection module 125 can be a contact tachometer, a non-contact tachometer, or a stroboscope.

As shown in FIG. 1, the system 100 can further includes a fin set 110. The fin set 110 has a front side 111 and a rear side 112 opposite to the front side 111. The fan 120 is disposed adjacent to the front side 111, and the airflow outlet 121 faces the front side 111. The sensor 130 is disposed near the rear side 112.

The fin set 110 can be columnar and can have a long edge, and the front side 111 and the rear side 112 are respectively disposed at ends of the long edge. In addition to the inhomogeneous airflow 123 in time series due to the rotation of the blades, the airflow 123 may make noises because the airflow 123 is extruded or collided by neighboring devices. Specifically, noises may be made because the airflow 123 is extruded or collided by the fin set 110. The aforementioned noises are made due to the flowing of the airflow 123, so the noises are transmitted mainly along with the flow direction of the airflow 123. Accordingly, the sensor 130 is disposed near the rear side 112, such that the sensor 130 is able to receive the fan noises in the airflow 123 leaving from the rear side 112 to receive precise information about the fan noise. In addition, because the sensor 130 is disposed in the leeward side, the airflow 123 in the fin set 110 may not be disturbed by the sensor 130, and the heat-dissipating performance may not be lowered.

The piezoelectric element 160 can be disposed at the center of the net structure 150. Therefore, the piezoelectric element 160 is able to vibrate to drive the whole net structure 150 to vibrate from the center of the net structure 150, and the whole net structure 150 may vibrate homogeneously and generate the offsetting sound to effectively offset the fan noise. Moreover, the center of the net structure 150 can be the center of the fan 120, and no airflow flows in the center area. Disposing the piezoelectric element 160 at the center of the net structure 150 may not obstruct the airflow from entering the fan 120, and the heat-dissipating performance of the fan 120 may not be lowered.

Because the inversed phase sound generated by the net structure 150 should exactly offset the fan noise to achieve noise control, the net structure 150 should be fixed, so as to generate accurate inversed phase sound when the net structure is vibrating. Accordingly, the net structure 150 can have a plurality of fixing members 151, the fixing members 151 is connected to the fan 120, so that the net structure 150 is stably fixed to the fan 120. Specifically, the fan 120 can have four corners 124, and the net structure 150 can have four fixing members 151. The net structure 150 is fixed to the corners 124 via the fixing members 151.

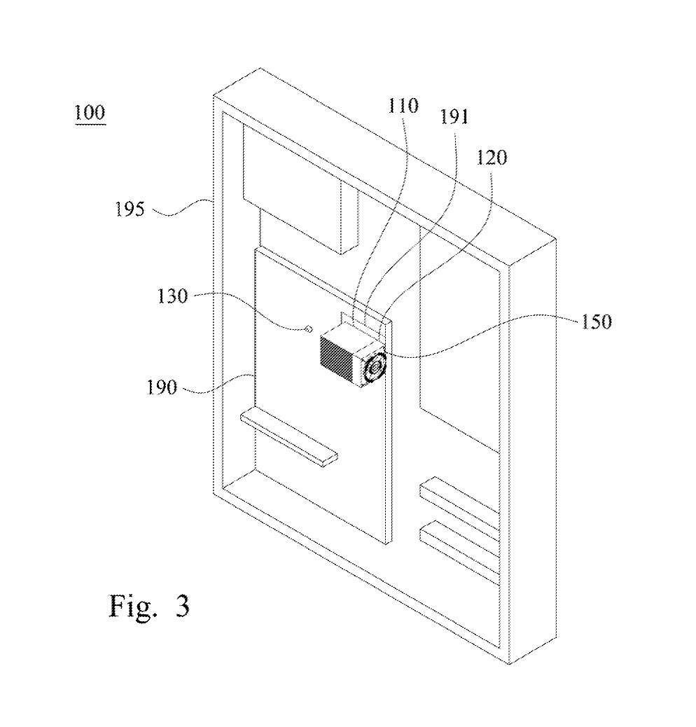

FIG. 3 is a perspective view of the system installed in a personal computer according to one embodiment of this invention. As shown in FIG. 1 and FIG. 3, the system 100 can further include a motherboard 190. The motherboard 190 can have a central processing unit 191, and the fin set 110 is disposed on the central processing unit 191. Therefore, the central processing unit 191 can first dissipate heat to the fin set 110, and then the fan 120 generates the airflow 123, which contacts with the fin set 110 and takes away the heat in the fin set 110, so as to effectively cool the central processing unit 191. The signal processing unit 140 can be a software or a firmware installed in the motherboard 190. The system 100 can further include a case 195, and the sensor 130 is disposed on the case 195.

By vibrating the net structure 150, which is disposed at the airflow inlet 122 and prevents dust or dirt from entering the fan 120, the inversed phase sound is generated according to the active noise cancellation, so as to effectively eliminate the noise made by the fan 120.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, 6th paragraph. In particular, the use of “step of” in the claims herein is not intended to invoke the provisions of 35 U.S.C. §112, 6th paragraph.

What is claimed is:

1. A system for controlling fan noise, comprising:
a fan having an airflow inlet and an airflow outlet;
a sensor receiving a sound signal made by the fan;
a signal processing unit receiving the sound signal sent by the sensor and analyzing the sound signal to compute an inversed phase signal;
a net structure disposed at the airflow inlet; and
a piezoelectric element receiving the inversed phase signal provided by the signal processing unit and vibrating according to the inversed phase signal so as to drive the net structure to vibrate and generate an inversed phase sound to offset a noise made by the fan.

2. The system of claim 1, wherein the sound signal is a mixed signal of a sound made by the net structure and a sound made by the fan.

3. The system of claim 2, wherein the fan and the sensor are separated to assure that the mixed signal is thoroughly mixed by the sound made by the fan and the sound made by the net structure.

4. The system of claim 1, wherein the fan has four corners, the net structure has four fixing members, and the net structure is fixed to the corners via the fixing members.

5. The system of claim 1, wherein the piezoelectric element is disposed at the center of the net structure.

6. The system of claim 1, wherein the fan has a rotation speed detection module for providing the signal processing unit a fan rotation speed signal as a reference signal for analyzing and computing the inversed phase signal.

7. A system for actively controlling fan noise, comprising:
a fin set having a front side and a rear side opposite to the front side;
a fan disposed adjacent to the front side and having an airflow inlet and an airflow outlet, wherein the airflow outlet faces the front side;
a sensor disposed near the rear side, for receiving a sound signal made by the fan;
a signal processing unit receiving the sound signal sent by the sensor, and analyzing the sound signal to compute an inversed phase signal;
a net structure disposed at the airflow inlet; and
a piezoelectric element receiving the inversed phase signal provided by the signal processing unit, and vibrating according to the inversed phase signal so as to drive the net structure to vibrate and generate an inversed phase sound to offset a noise made by the fan.

8. The active fan noise cancellation system of claim 7, wherein the sound signal is a mixed signal of a sound made by the net structure and a sound made by the fan.

9. The system of claim 7, wherein the fin set is columnar and has a long edge, and the front side and the rear side are respectively disposed at both ends of the long edge.

10. The system of claim 7, further comprising a motherboard, wherein the motherboard has a central processing unit, the fin set is disposed on the central processing unit.
